(19) United States
(12) Patent Application Publication
(10) Pub. No.: US 2006/0052082 A1
(43) Pub. Date: Mar. 9, 2006

(54) Cellular telephone billing method featuring variable rate depending on amount of service consumed during service interval

(76) Inventor: Jean E. Whewell, Georgetown, TX (US)

Correspondence Address: Christopher J. Whewell;Western Patent group, 6020 Tonkowa Trail, Georgetown, TX, 78628, US

(21) Appl. No.: 10/933,562

(22) Filed: Sep. 4, 2004

(51) Int. Cl. H04M 11/00

(52) U.S. Cl. 455/406

(57) ABSTRACT

Provided herein is a billing method for cellular service providers to offer customers which take into account the fact that an individual's use varies from one service interval to the next, and automatically adjusts the amount invoiced to the consumer based on the minutes of service actually consumed by a given consumer during a service interval. The amount of money invoiced to the consumer is adjusted for each service interval, with the net effect being the reduction of the total amount of money that the consumer is invoiced over a plurality of service intervals, versus the amount the same consumer would have been otherwise invoiced for identical consumption over the same plurality of service intervals under a single plan featuring a fixed level of threshold minutes and a fixed rate per minute for each minute consumed in excess of the threshold minutes.

### CROSS-REFERENCES TO RELATED APPLICATIONS

The present application claims priority to U.S. patent application Ser. No. 10/230,852 filed on Aug. 29, 2002, currently still pending.

### TECHNICAL FIELD

This invention relates to cellular telephone service and billing plans useful by providers of such service to invoice their customers for such service.

### BACKGROUND

Cellular telephone services are in widespread use. Providers of such services offer different billing plans to prospective customers under which the different plans have differing amounts of threshold levels of minutes that a user may consume for a flat fee. If the user exceeds the threshold amount of plan minutes within a given billing cycle, the user must pay a rate per minute for minutes in excess of the plan amounts. Often, the rate per minute for minutes used in excess of the plan threshold level of minutes is punitive in a sense that it is much higher than the rate per minute calculated from the basic plan amount divided by the number of threshold minutes provided under such a plan. This puts the consumer at a disadvantage as far as cost is concerned with respect to minutes consumed beyond the plan amount, and my cause negative feelings in the mind of the consumer towards the service provider, thus causing the consumer to break a contract or to seek alternative sources of cellular services after expiry of a contract. What is needed therefore, is a billing plan which does not penalize consumers for excessive use of cellular services and which increases consumer loyalty to a provider of cellular services.

### BRIEF DESCRIPTION OF THE DRAWING

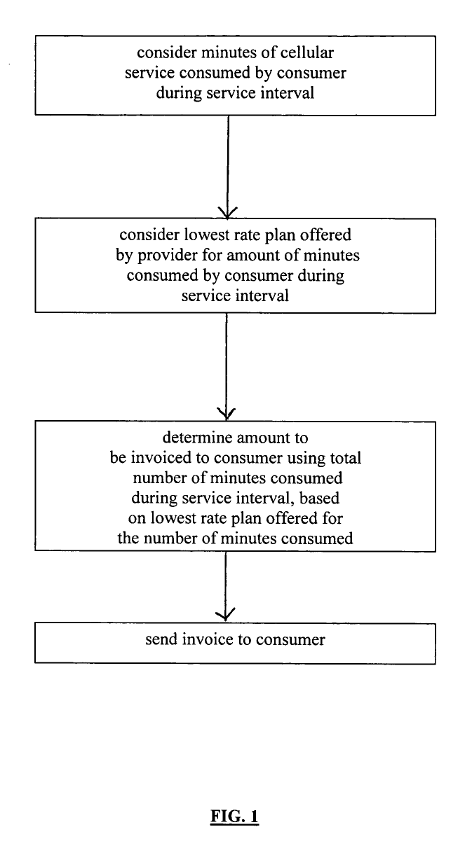

In the annexed drawing, FIG. 1 represents a flow chart of a method according to the present invention.

### SUMMARY OF THE INVENTION

The present invention provides a variable billing plan method for calculating an invoice amount for a consumer of cellular telephone services during a service interval. A method according to the invention comprises the steps of: a) offering a consumer a plurality of billing schedules from which to choose, wherein each of the schedules includes a pre-determined threshold level of given plan minutes which are billed at a flat rate and a rate per minute for each minute of service used which exceeds the threshold level, and wherein each of the plurality of billing schedules offered includes a different amount of pre-determined threshold level of given plan minutes: accepting a billing schedule choice selection from the consumer, wherein the choice includes a pre-determined threshold level of given plan minutes which are billed at a flat rate and a rate per minute for each minute of service used which exceeds the threshold level; c) providing cellular telephone service to the consumer during a service interval; d) calculating an invoice amount based upon the accepted billing schedule choice by combining the total dollar values of the flat rate and an addend that is calculated by multiplying the number of minutes of service used that exceed the threshold level by the rate per minute charged for each minute exceeding the threshold level; e) calculating a hypothetical invoice amount based upon a billing plan that was offered to the consumer but which was not selected by the consumer, using the actual minutes of service used by the customer during the service interval, by combining the dollar value for the threshold level of given minutes for the plan not selected, and the rate for each minute in excess of the threshold level for the plan not selected, to arrive at a hypothetical invoice amount for a plan not selected; f) repeating step e) for each of all of the plans offered but not selected, so as to provide a hypothetical invoice amount for each plan not selected; g) comparing the hypothetical invoice amount(s) with the invoice amount from step d) to determine which out of all of the invoice amount and the hypothetical invoice amount(s) is the least dollar value; and h) issuing an invoice to the customer using the least dollar value as a pre-tax basis for the invoice.

### DETAILED DESCRIPTION

Cellular service providers offer the public different billing plans from which each individual user may choose, which best suits their personal calling needs. Typically, such services offer several different billing schedules to prospective customers to entice them to enter into contractual obligations with the service provider. Typically, the billing schedules offered include a pre-determined threshold level of minutes that the consumer may use, in exchange for a flat billing amount. In the event that the consumer utilizes more minutes of cellular service than specified as the pre-determined threshold level, the consumer is billed on a per-minute basis for each minute in excess of the threshold level of minutes in the plan accepted by the consumer. The invoice at the end of the service interval, which is typically monthly, is calculated by adding the total dollar values of the flat rate and an addend that is calculated by multiplying the number of minutes of service used that exceed the threshold level by the rate per minute charged for each minute exceeding the threshold level. Taxes and other fees may then be added on and a final invoice amount is billed to the consumer.

A typical offering of a plurality of billing schedules is set forth below in Table I:

TABLE I
common plurality of billing schedule options offered to consumers of
cellular service.

| | Monthly Service | Threshold Level | Additional Minutes |
|---|---|---|---|
| Plan Number | Charge | of Minutes | Cost |
| 1 | $34.99 | 300 | 40 cents |
| 2 | $49.99 | 500 | 40 cents |
| 3 | $74.99 | 1000 | 40 cents |
| 4 | $99.99 | 1300 | 40 cents |
| 5 | $149.99 | 2200 | 40 cents |
| 6 | $199.99 | 3200 | 40 cents |

Thus, a consumer operating under plan 1 who used 400 minutes per service interval would be invoiced an amount equal to the monthly service charge of $34.99 plus an additional $40.00, derived from multiplying 100 minutes excessive of the threshold level of 300 minutes times the rate of 40 cents per minute.

Similarly, a consumer operating under plan 1 who used 600 minutes during the service interval would be invoiced based on an amount of $34.99 plus $120.00.

Certainly, it is to the consumer's advantage to select the plan which is well-suited to their individual needs. However, prediction of service usage by consumers is not always accurate due to fluctuating individual needs. If a cellular service provider were to offer their consumers and prospective consumers a variable rate billing plan which saved the consumer money during unpredictable fluctuations in their service, the consumer would appreciate the cost savings that such a variable billing plan would offer. A cellular service provider which offered a variable billing plan according to the invention would be very likely to attract customers away from their competition, and would appreciate significant long-term overall financial gains relative to their competition realized by an increased subscriber base, with relatively little increase in bandwidth usage.

According to the present invention the regular amount that a consumer would be billed under an accepted billing schedule is calculated. Then, a hypothetical invoice amount is calculated based upon a billing plan that was offered to the consumer but which was not selected by the consumer, using the actual minutes of service used by the customer during the service interval, by combining the dollar value for the threshold level of given minutes for the plan not selected, and the rate for each minute in excess of the threshold level for the plan not selected, to arrive at a hypothetical invoice amount for a plan not selected. This is repeated for each of the plans that were offered but not selected, so as to provide a hypothetical invoice amount for each plan not selected. Then, the hypothetical invoice amount(s), (when more than two plans were offered to the consumer) are compared with the regular amount that the consumer would be billed under the accepted billing schedule (the “actual amount”) to determine which dollar value out of all of the hypothetical and actual amounts is the lowest cost to the consumer. The lowest value is selected as a basis for invoicing the customer, to which taxes and other customary fees are added to yield a final invoice amount which must be paid by the consumer.

In one preferred embodiment of the invention, in exchange for the valuable variable billing plan according to the invention, the consumer of cellular services is levied a surcharge on their invoice for the use of the variable plan.

Thus, a consumer of cellular services operating under plan 1 of Table I who uses 400 minutes in the service interval would have an actual amount for billing as set forth in Table III below next to plan 1, with the rest of the dollar values being the hypothetical invoice amounts:

TABLE II
Invoice amounts for person operating under plan 1 from Table I who
uses 400 minutes of service during the service interval.

| Plan Number | Invoice Amounts |
|---|---|
| 1 | $74.99 (actual) |
| 2 | $49.99 (hypothetical) |
| 3 | $74.99 (hypothetical) |
| 4 | $99.99 (hypothetical) |
| 5 | $149.99 (hypothetical) |
| 6 | $199.99 (hypothetical) |

According to the present invention, the dollar figures from the right-hand column of Table II would be compared with one another to discover that the lowest dollar amount is $49.99. This is the amount which would be used as a basis for calculating the consumer's invoice, thus saving the consumer $30.00. The service provider, in one embodiment, would charge the consumer a surcharge for the use of a plan according to the present invention, which could be any amount between 0 and the amount saved. While it is most preferred that the surcharge is about one-half of the savings to the consumer, the present invention contemplates surcharges which are any dollar value between zero and the amount saved through use of the plan.

As another example, a consumer operating under plan 1 in Table I who uses 600 minutes of service would have an actual amount for billing as set forth in Table III below next to plan 1, with the rest of the dollar values being the hypothetical invoice amounts:

TABLE III
Invoice amounts for person operating under plan 1 from Table I who
uses 600 minutes of service during the service interval.

| Plan Number | Invoice Amounts |
|---|---|
| 1 | $154.99 (actual) |
| 2 | $89.99 (hypothetical) |
| 3 | $74.99 (hypothetical) |
| 4 | $99.99 (hypothetical) |
| 5 | $149.99 (hypothetical) |
| 6 | $199.99 (hypothetical) |

Thus, the lowest billing amount for a person operating under plan 1 who uses 600 minutes of service but calculated according to a method of the present invention would be $74.99. This could represent a maximum amount of savings of $80.00 to the consumer.

Thus, it is evident from the foregoing, that it is an inherent feature of the present invention to take into account the fact that an individual's use varies from one service interval to the next, and to provide a billing method for cellular telephone services which is designed to automatically adjust the amount invoiced to the consumer based on the minutes of service actually consumed by a given consumer during a service interval. The amount of money invoiced to the consumer is adjusted for each service interval so as to reduce the total amount of money that the consumer is invoiced over a plurality of service intervals, versus the amount the same consumer would have been otherwise invoiced for identical consumption over the same plurality of service intervals under a single plan featuring a fixed level of threshold minutes and a fixed rate per minute for each minute consumed in excess of the threshold minutes.

Further, one of ordinary skill immediately recognizes that the prior art of cellular telephone services billing has shown for years that several different service providers each offer a plurality of plans from which consumers may choose, each of which plans contain various features, including differing levels of threshold minutes consumed and rates for minutes consumed in excess of the threshold values. By simple extension, it is apparent to anyone having a tincture of imaginative skill that it is within the realm of possibility for a given provider of cellular services to potentially offer literally thousands of billing plans, which each contain a wide range of possible threshold minutes which are billed at a flat rate, and a vast range of possible cents per minute values for each minute consumed above the threshold level, and that by coupling these features together, the number of possible billing plans becomes essentially infinite. By simple mathematical calculation, a tinctured imaginatarian could readily arrive at a schedule, if they were so inclined, reminiscent of IRS tax schedules, of dollar amounts to be invoiced to a consumer for consumption of service during a service interval which corresponds to each of the possible given billing plans contained by the infiniticity just described, including corresponding minutes consumed under each individual plan within the universe of possible plans and dollar values associated with each.

While the mechanical step of a comparison between an actual invoice amount and a hypothetical invoice amount was specified in the foregoing disclosure, it is clear that such machinations are merely exemplary of specific embodiments of the broader scope of the concept taught by the present invention which are useful for arriving at the necessary result implicit in this disclosure—namely an automatic adjustment of the consumers invoice based on the consumption of the consumer (which often fluctuates) in a way which reduces the amount which the customer is invoiced within a single service interval and hence necessarily over a plurality of service intervals, as compared to billing plans of the prior art. Therefore it is clear that the net result of the teachings of the principles of the present invention could lead to many situations in which substantially the same effective result is achieved using this same principles. As mentioned, the net effect of use of the principle of the invention is to attract customers away from service providers other than those using the principle(s) of the present invention, by offering and implementing a billing plan which fluctuates in accordance with the consumers use, in such a way which tends to reduce the amount which a consumer is billed as compared with billing plans of the prior art that feature a threshold level of minutes and a rate per minute for service in excess of the threshold level, for identical service by the same consumer, over a plurality of service intervals.

Use of a variable billing method according to the invention would not only attract consumers away from competitors in the cellular service market, but would also save consumers money while not adversely impacting bandwidth usage, all while increasing consumer loyalty.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. Accordingly, the presently disclosed invention is intended to cover all such modifications and alterations, and is limited only by the scope of the claims which follow.

I claim:

1) A flexible billing method for cellular telephone services which takes into account the minutes of cellular service consumed by a consumer during a service interval, and which method comprises the step of adjusting the amount of money invoiced to the consumer for each service interval so as to reduce the total amount of money that the consumer is invoiced over a plurality of service intervals, versus the amount the same consumer would have been otherwise invoiced for identical consumption over the same plurality of service intervals under a single plan featuring a fixed level of threshold minutes and a fixed rate per minute for each minute consumed in excess of said threshold minutes.

2) A method according to claim 1 wherein said adjusting is automatic, based on the minutes of cellular service consumed during said service interval.

3) A method according to claim 1 wherein said service interval is one month.

4) A method according to claim 1 wherein said plurality of service intervals is a plurality of months.

5) A method according to claim 1 wherein the amount invoiced to the consumer is automatically adjusted in such a way as to reduce the total amount of money that the consumer is invoiced over a plurality of service intervals, versus the amount the same consumer would have been otherwise invoiced for identical consumption over the same plurality of service intervals under a single plan featuring a fixed level of threshold minutes and a fixed rate per minute for each minute consumed in excess of said threshold minutes.

6) A method according to claim 5 wherein the consumer's consumption of minutes fluctuates such that the total consumed during at least one service interval is in excess of said threshold level of minutes.

7) A flexible billing method for cellular telephone services which takes into account the minutes of cellular service consumed by a consumer during a service interval, and which method comprises the step of adjusting the overall cost per minute of cellular service for which a consumer is invoiced such that the total amount that the consumer is invoiced over a plurality of service intervals is less than the amount the same consumer would have been otherwise invoiced for identical consumption over the same plurality of service intervals.

8) A method according to claim 7 wherein said adjusting is automatic, based on the minutes of cellular service consumed during each service interval.

9) A method according to claim 7 wherein said service interval is one month.

10) A method according to claim 7 wherein said plurality of service intervals is a plurality of months.

11) A method according to claim 7 wherein the amount invoiced to the consumer is automatically adjusted in such a way as to reduce the total amount of money that the consumer is invoiced over a plurality of service intervals, versus the amount the same consumer would have been otherwise invoiced for identical consumption over the same plurality of service intervals under a single plan featuring a fixed level of threshold minutes and a fixed rate per minute for each minute consumed in excess of said threshold minutes.

12) A method according to claim 11 wherein the consumer's consumption of minutes fluctuates such that the total consumed during at least one service interval is in excess of said threshold level of minutes.

13) A billing method for cellular telephone services which takes into consideration the minutes of cellular service consumed by a consumer during a service interval, and which comprises the step of automatically adjusting the overall cost per minute of cellular service for which a consumer is invoiced for each service interval such that the total amount that the consumer is invoiced over a plurality of service intervals is less than the amount the same consumer would have been invoiced under any one fixed plan that features a fixed level of threshold minutes and a set rate per minute for each minute consumed in excess of said threshold minutes for identical consumption over the same plurality of service intervals.

14) A method of advertising cellular telephone services which comprises offering consumers a flexible billing method which takes into account the minutes of cellular service consumed by a consumer during a service interval, and which method comprises the step of adjusting the amount of money invoiced to the consumer for each service interval so as to reduce the total amount of money that the consumer is invoiced over a plurality of service intervals, versus the amount the same consumer would have been otherwise invoiced for identical consumption over the same plurality of service intervals under a single plan featuring a fixed level of threshold minutes and a fixed rate per minute for each minute consumed in excess of said threshold minutes.
